(19) United States
(12) Patent Application Publication
(10) Pub. No.: US 2015/0102727 A1
(43) Pub. Date: Apr. 16, 2015

(54) LED DRIVER CIRCUIT CAPABLE OF EXTENDING A LIFESPAN OF THE LED DRIVER AND REDUCING MANUFACTURING COST

(71) Applicant: LEXTAR ELECTRONICS CORPORATION, Hsinchu (TW)

(72) Inventors: Chun-Kuang CHEN, Taipei City (TW); Po-Shen CHEN, Hsinchu City (TW)

(21) Appl. No.: 14/325,232

(22) Filed: Jul. 7, 2014

(30) Foreign Application Priority Data
Oct. 15, 2013 (TW) 102137077

(51) Int. Cl. H05B 33/08

(52) U.S. Cl. CPC H05B 33/0815; H05B 33/0854
USPC 315/136; 315/307; 315/159

(57) ABSTRACT

An LED driver circuit includes a first driver, a second driver, a switch, a first detection module, a second detection module and a control module. The first driver provides a first driving current according to a supply voltage. The second driver provides a second driving current according to the supply voltage. The switch is selectively coupled to the first or second driver. An LED emits light according to the first or second driving current. When the switch is coupled to the first driver, the first detection module keeps detecting the first driving current and outputting a first sensing signal. When the switch is coupled to the second driver, the second detection module keeps detecting the second driving current and outputting a second sensing signal. The control module outputs a first or second control signal according to the first or second sensing signal for controlling the switch.

### CROSS REFERENCE TO RELATED APPLICATIONS

This Application claims priority of Taiwan Patent Application No. 102137077, filed on Oct. 15, 2013, the entirety of which is incorporated by reference herein.

### BACKGROUND OF THE INVENTION

1. Field of the Invention

The invention relates to a Light Emitting Diode (LED) driver circuit, and more particularly to an LED driver circuit capable of extending a lifespan of the LED driver and reducing manufacturing cost.

2. Description of the Related Art

LEDs have in recent years become extensively developed and mass produced in accordance with advances in providing higher luminance, long lifespan, good color rendering, wide flexibility in colors, and low energy consumption. Typically, an LED light product is provided with an LED and an LED driver chip which is responsible for driving the LED. However, the lifespan of the LED driver is usually shorter than the LED because the lifespan is limited by the rated value of the electronic elements comprised therein, such as the capacitors.

Therefore, a novel LED driver circuit architecture capable of extending the lifespan of the LED driver is highly required.

### BRIEF SUMMARY OF THE INVENTION

LED driver circuits are provided. An exemplary embodiment of an LED driver circuit coupled between a supply voltage and an LED comprises a first driver, a second driver, a switch, a first detection module, a second detection module and a control module. The first driver provides a first driving current according to the supply voltage. The second driver provides a second driving current according to the supply voltage. The switch is coupled to a voltage source for providing the supply voltage and selectively coupled to the first or second driver, thereby the LED emits light according to the first driving current or the second driving current. The first detection module is disposed between the first driver and the LED. When the switch is coupled to the first driver, the first detection module keeps detecting the first driving current and keeps outputting a first sensing signal. The second detection module is disposed between the second driver and the LED. When the switch is coupled to the second driver, the second detection module keeps detecting the second driving current and keeps outputting a second sensing signal. The control module is coupled to the first detection module, the second detection module and the switch, and outputs a first control signal or a second control signal for controlling the switch to be switched to couple to the first driver or the second driver according to the first sensing signal or the second sensing signal.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of an LED driver circuit according to an embodiment of the invention;

FIG. 2A is a waveform showing the voltage of a sensing signal according to an embodiment of the invention;

FIG. 2B is a waveform showing the voltage of a sensing signal according to another embodiment of the invention;

FIG. 2C is a waveform showing the voltage of a sensing signal according to yet another embodiment of the invention; and

FIG. 3 is a flow chart showing the functioning of the LED driver circuit according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

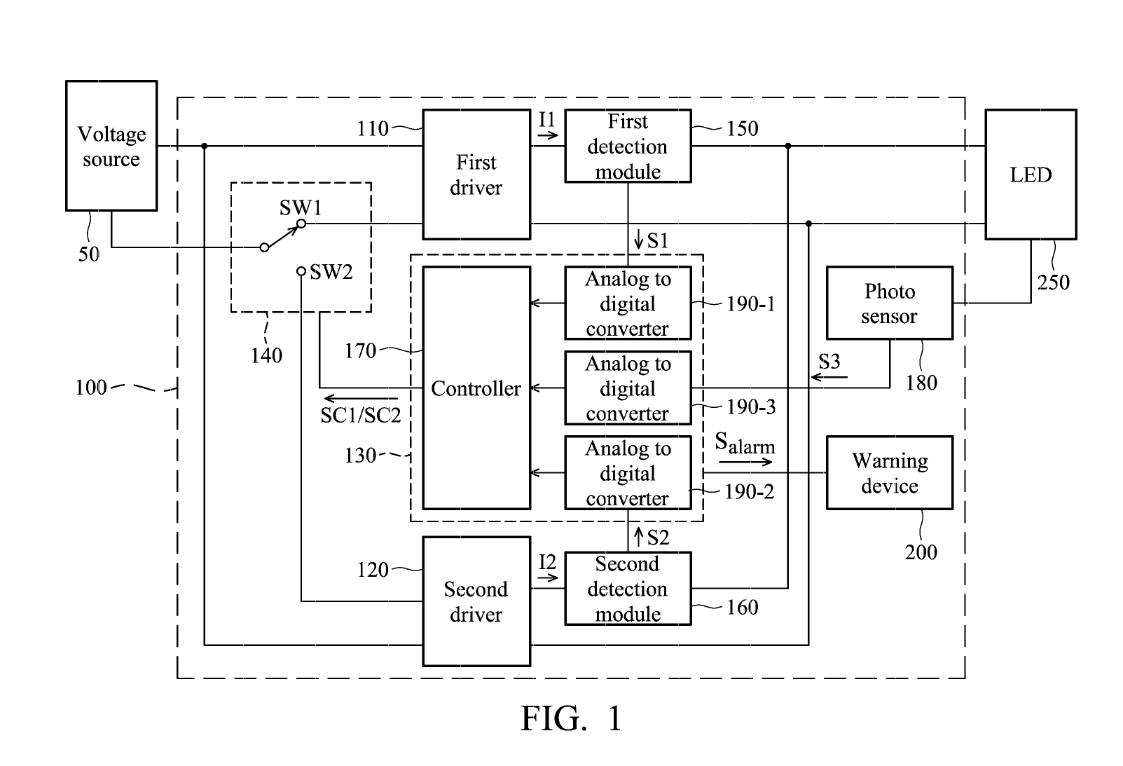

FIG. 1 is a block diagram of an LED driver circuit according to an embodiment of the invention. The LED driver circuit 100 is coupled between a voltage source 50 for providing a supply voltage and an LED 250. The LED driver circuit 100 accompanying with the LED 250 may form a light emitting device, such as a panel light, and the light emitting device emits light according to the supply voltage provided by the voltage source 50.

According to an embodiment of the invention, the LED driver circuit 100 may comprise a first driver 110, a second driver 120, a control module 130, a switch 140, a first detection module 150, a second detection module 160 and a photo sensor 180. The first driver 110 generates a first driving current I1 according to the supply voltage. The second driver 120 generates a second driving current I2 according to the supply voltage. The switch 140 is coupled to the voltage source 50 and selectively coupled to the first driver 110 or the second driver 120 thereby the LED 250 emits light according to the first driving current I1 or the second driving current I2. As shown in FIG. 1, the switch 140 may comprise two terminals SW1 and SW2. When the switch 140 is switched to the terminal SW1, the voltage source 50 is coupled to the first driver 110 for providing the supply voltage to the first driver 110. When the switch 140 is switched to the terminal SW2, the voltage source 50 is coupled to the second driver 120 for providing the supply voltage to the second driver 120.

According to an embodiment of the invention, the first detection module 150 and the second detection module 160 may respectively comprise a current sensor. The first detection module 150 is disposed between the first driver 110 and the LED 250 to keep detecting the first driving current I1 and generating the first sensing signal S1 according to the detected first driving current I1 when the switch 140 is switched to couple to the first driver 110. The second detection module 160 is disposed between the second driver 120 and the LED 250 to keep detecting the second driving current I2 and generating the second sensing signal S2 according to the detected second driving current I2 when the switch 140 is switched to couple to the second driver 120.

The photo sensor 180 is coupled between the LED 250 and the control module 130 for sensing a luminance of the light emitted by the LED 250 and outputting a third sensing signal S3 according to the luminance.

The control module 130 is coupled to the first detection module 150, the second detection module 160, the photo sensor 180 and the switch 140 and outputs a first control signal SC1 or a second control signal SC2 for controlling the switch 140 to be switched to couple to the first driver 110 or the second driver 120 according to the first sensing signal S1, the second sensing signal S2 and the third sensing signal S3.

According to an embodiment of the invention, the first sensing signal S1, the second sensing signal S2 and the third sensing signal S3 are respectively the first analog sensing signal, the second analog sensing signal and the third analog sensing signal. The control module 130 may comprise analog to digital converters 190-1, 190-2 and 190-3 and a controller 170. The analog to digital converter 190-1 is coupled to the first detection module 150 for converting the first analog sensing signal to the first digital sensing signal. The analog to digital converter 190-2 is coupled to the second detection module 160 for converting the second analog sensing signal to the second digital sensing signal. The analog to digital converter 190-3 is coupled to the photo sensor 180 for converting the third analog sensing signal to the third digital sensing signal. The controller 170 is coupled between the analog to digital converters 190-1, 190-2 and 190-3 and the switch 140 for generating the first control signal SC1 or the second control signal SC2 for controlling the switch 140 according to the received first, second and third digital sensing signal.

According to an embodiment of the invention, the switch 140 is initially coupled to the first driver 110, such that the supply voltage may be provided to the first driver 110. The first driver 110 generates the first driving current I1 according to the supply voltage. The first detection module 150 keeps detecting the first driving current I1 and generating the first sensing signal S1 according to the detected first driving current I1. The LED 250 emits light according to the first driving current I1 and the photo sensor 180 keeps sensing the luminance of the light generated by the LED 250 and outputting the third sensing signal S3 according to the luminance. The controller 170 determines whether the LED 250 emits light normally according to the first digital sensing signal received from the analog to digital converter 190-1 and the third digital sensing signal received from the analog to digital converter 190-3.

According to an embodiment of the invention, the controller 170 comprises a reference signal S_{rf}. The controller 170 determines whether the received sensing signal is abnormal according to the reference signal S_{rf}. When the first digital sensing signal (that is, corresponding to the first sensing signal S1) and the third digital sensing signal (that is, corresponding to the third sensing signal S3) are both not different from the reference signal S_{rf}, it means that the first driver 110 functions normally and the LED 250 emits light normally. At this time, the controller 170 keeps outputting the first control signal SC1, thereby the switch 140 remaining coupled to the first driver 110.

When the first digital sensing signal (that is, corresponding to the first sensing signal S1) or the third digital sensing signal (that is, corresponding to the third sensing signal S3) is different from the reference signal S_{rf}, it means that the first driver 110 functions abnormally or the LED 250 emits light abnormally. The controller 170 stops outputting the first control signal SC1 and outputs the second control signal SC2, thereby the switch 140 is switched to couple to the second driver 120 in response to the second control signal SC2.

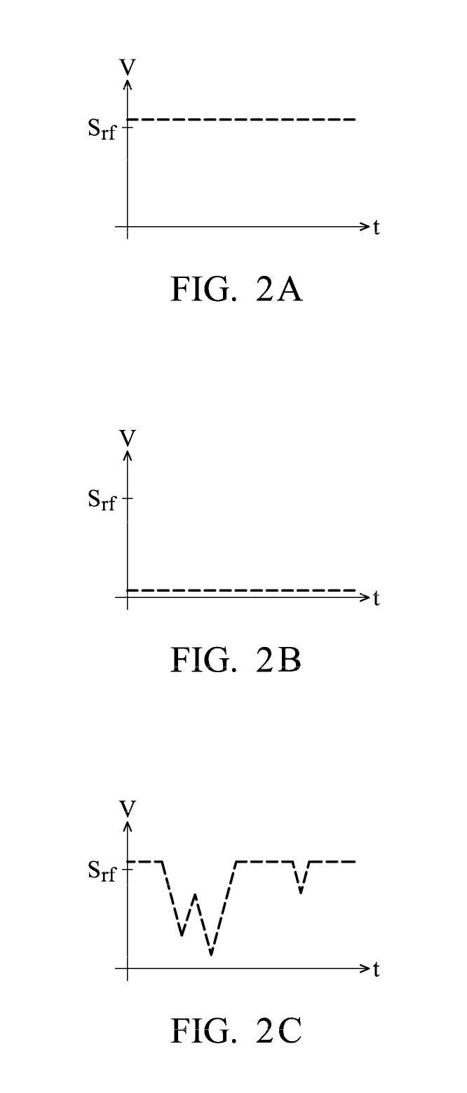

For example, when the first driver 110 starts up normally and functions normally, the value of the first digital sensing signal (that is, corresponding to the first sensing signal S1) read by the controller 170 is a normal value. At this time, when the LED 250 emits light normally, the value of the third digital sensing signal (that is, corresponding to the third sensing signal S3) read by the controller 170 is a stable voltage value, such as the waveform of the sensing signal shown in FIG. 2A, wherein the x-axis represents the time (t) and the y-axis represents the voltage (V). At this time, the controller 170 determines the driver circuit functions normally and continuous outputting the first control signal SC1.

In another example, when the first driver 110 is unable to start up normally or the LED 250 is unable to emit light normally, the value of the first/third digital sensing signal (that is, corresponding to the first/third sensing signal S1/S3) read by the controller 170 is not a normal value, such as the waveform of the sensing signal shown in FIG. 2B. At this time, the controller 170 may determine that the driver circuit functions abnormally, stop outputting the first control signal SC1, and output the second control signal SC2.

In yet another example, when the first driver 110 starts up normally and functions normally, the value of the first digital sensing signal (that is, corresponding to the first sensing signal S1) read by the controller 170 is a normal value. However, if the LED 250 is unable to emit light normally, for example, when blinking occurs due to the luminance being unstable, the value of the third digital sensing signal (that is, corresponding to the third sensing signal S3) read by the controller 170 is not a stable voltage value, such as the waveform of the sensing signal shown in FIG. 2C. At this time, the controller 170 may determine that the driver circuit is functioning abnormally, stop outputting the first control signal SC1, and output the second control signal SC2.

When the switch 140 is switched to couple to the second driver 120, the voltage source 50 provides the supply voltage to the second driver 120. The second driver 120 generates the second driving current I2 according to the supply voltage and the second detection module 160 keeps detecting the second driving current I2 and outputting the second sensing signal S2 according to the detected second driving current I2. The LED 250 emits light according to the second driving current I2 and the photo sensor 180 keeps sensing the luminance of the light generated by the LED 250 and outputting the third sensing signal S3 according to the luminance. The controller 170 determines whether the LED 250 emits light normally according to the second digital sensing signal received from the analog to digital converter 190-2 and the third digital sensing signal received from the analog to digital converter 190-3.

When the second digital sensing signal (corresponding to the second sensing signal S2) and the third digital sensing signal (corresponding to the third sensing signal S3) are both not different from the reference signal S_{rf}, it means that the second driver 120 functions normally and the LED 250 emits light normally. At this time, the controller 170 keeps generating the second control signal SC2, thereby the switch 140 keeps coupling to the second driver 120. The concept of determining whether the LED 250 emits light normally according to the second digital sensing signal and the third digital sensing signal is similar to the concept of determining whether the LED 250 emits light normally according to the first digital sensing signal and the third digital sensing signal. For further discussion, reference may be made to the above paragraphs, and may be omitted here for brevity.

When the second digital sensing signal (corresponding to the first sensing signal S1) or the third digital sensing signal (corresponding to the third sensing signal S3) is still not different from the reference signal S_{rf}, it means that the second driver 120 functions abnormally or the LED 250 is unable to emit light. At this time, the controller 170 outputs a warning signal Sₐₗₐᵣₘ to the warning device 200 for the warning device 200 to generate an abnormal warning.

According to an embodiment of the invention, the warning device 200 may be a small light emitting device. When the warning device 200 lights up, it means the LED 250 or the LED driver circuit 100 functions abnormally. When the user is aware of the abnormal warning, the user may do some further actions for processing the abnormality.

Note that in the embodiments of the invention, the reference signal S_{rf} comprised in the controller 170 is not limited to a single value, and may be a set of values (for example, a set of values comprising more than one reference value, each reference value may correspond to a sensing signal), or a range of values, and the invention should not be limited to any single case.

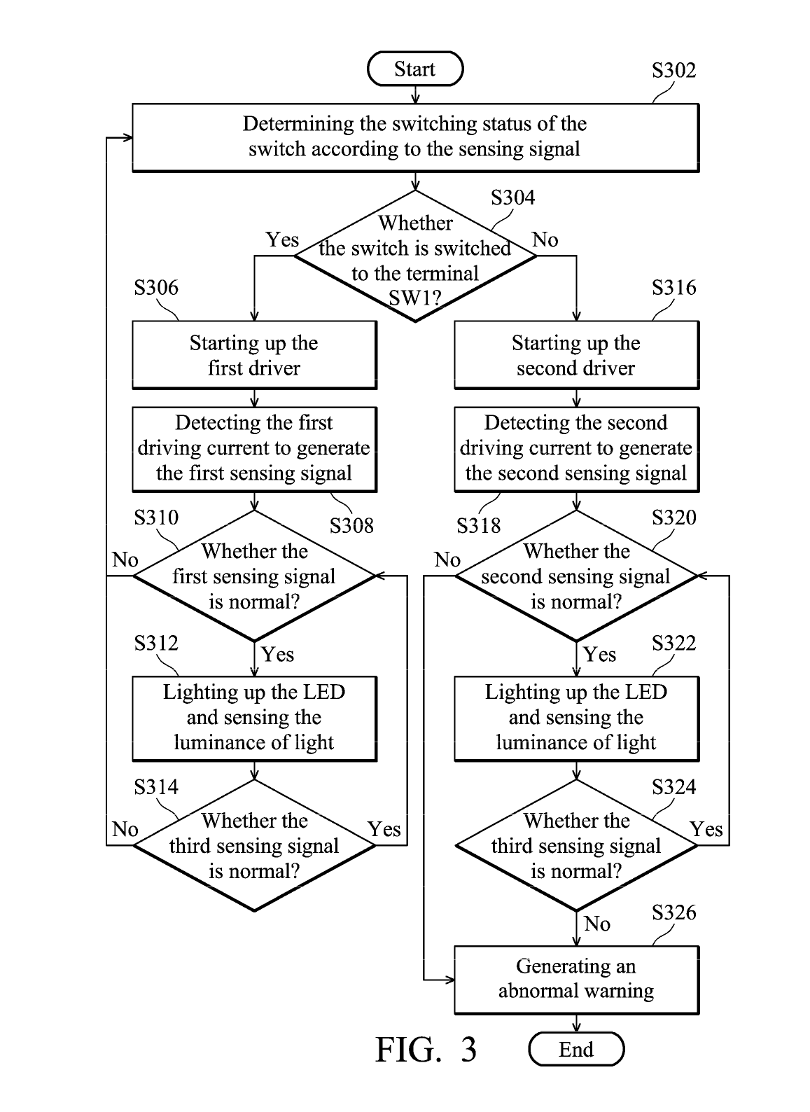

FIG. 3 is a flow chart showing the functioning of the LED driver circuit according to an embodiment of the invention. When receiving the supply voltage, the LED driving circuit starts functioning. The controller initially controls the switch to be switched to couple to the first driver. For example, when the LED driving circuit starts functioning, the controller outputs the first control signal SC1 by default. Next, the controller keeps determining a switching status of the switch according to the received sensing signal (Step S302). When the switch is switched to the terminal SW1 (the “yes” path of step S304), the first driver is started up to generate the first driving current (Step S306). Next, the first detection module detects the first driving current to generate the first sensing signal (Step S308). Next, the controller determines whether the first sensing signal is normal (Step S310). If the first sensing signal is normal, the LED lights up and the photo sensor senses the luminance of the light generated by the LED to output the third sensing signal (Step S312). Next, the controller determines whether the third sensing signal is normal (Step S314). When the third sensing signal is normal, the process returns to step S310 and the controller keeps determining whether the first sensing signal is normal. If the first sensing signal is abnormal or the third sensing signal is abnormal, the process returns to step S302 for the controller to determine the switching status of the switch. As discussed above, when abnormality occurs, the controller outputs the second control signal SC2, whereby the switch is coupled to the second driver.

On the other hand, when the switch is switched to the terminal SW2 (the “no” path of step S304), the second driver is started up to generate the second driving current (Step S316). Next, the second detection module detects the second driving current to generate the second sensing signal (Step S318). Next, the controller determines whether the second sensing is normal (Step S320). If the second sensing signal is normal, the LED lights up and the photo sensor senses the luminance of the light generated by the LED to output the third sensing signal (Step S322). Next, the controller determines whether the third sensing signal is normal (Step S324). When the third sensing signal is normal, the process returns to step S320 and the controller keeps determining whether the second sensing signal is normal. If the second sensing signal is abnormal or the third sensing signal is abnormal, the controller generates the warning signal to the warning device for the warning device to generate an abnormal warning (Step S326).

The proposed LED driver circuit extends the lifespan of the LED driver by setting two or more drivers. In addition, since the proposed LED driver circuit further unifies the design of the control module, the proposed LED driver circuit can be generally applied in any long-acting light emitting products and the cost of manufacturing the corresponding products can be reduced.

The above-described embodiments of the present invention can be implemented in any of numerous ways. For example, the embodiments may be implemented using hardware, software or a combination thereof. It should be appreciated that any component or collection of components that perform the functions described above can be generically considered as one or more processors that control the above discussed function. The one or more processors can be implemented in numerous ways, such as with dedicated hardware, or with general purpose hardware that is programmed using microcode or software to perform the functions recited above.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An LED driver circuit, coupled between a supply voltage and an LED, comprising:
a first driver, providing a first driving current according to the supply voltage;
a second driver, providing a second driving current according to the supply voltage;
a switch, coupled to a voltage source for providing the supply voltage and selectively coupled to the first or second driver, whereby the LED emits light according to the first driving current or the second driving current;
a first detection module, disposed between the first driver and the LED, wherein when the switch is coupled to the first driver, the first detection module keeps detecting the first driving current and keeps outputting a first sensing signal (S1);
a second detection module, disposed between the second driver and the LED, wherein when the switch is coupled to the second driver, the second detection module keeps detecting the second driving current and keeps outputting a second sensing signal (S2); and
a control module, coupled to the first detection module, the second detection module and the switch, and outputting a first control signal or a second control signal for controlling the switch to be switched to couple to the first driver or the second driver according to the first sensing signal (S1) or the second sensing signal (S2).

2. The LED driver circuit as claimed in claim 1, wherein the switch is initially coupled to the first driver, the control module comprises a reference signal (S_{rf}), when the first sensing signal (S1) is different from the reference signal (S_{rf}), the control module stops outputting the first control signal and outputs the second control signal, thereby the switch is switched to couple to the second driver in response to the second control signal.

3. The LED driver circuit as claimed in claim 2, further comprising a photo sensor coupled between the LED and the control module for sensing a luminance of the light emitted by the LED and outputting a third sensing signal (S3) to the control module according to the luminance.

4. The LED driver circuit as claimed in claim 3, wherein when the switch is coupled to the first driver and the first sensing signal (S1) is not different from the reference signal (S_{rf}) but the third sensing signal (S3) is different from the reference signal (S_{rf}), the control module stops outputting the first control signal and outputs the second control signal, thereby the switch is switched to couple to the second driver in response to the second control signal.

5. The LED driver circuit as claimed in claim 4, further comprising an warning device coupled to the control module, wherein when the third sensing signal (S3) or the second sensing signal (S2) is still different from the reference signal (S_{rf}) after the switch being coupled to the second driver, the control module outputs a warning signal (Sₐₗₐᵣₘ) to the warning device to generate an abnormal warning.

6. The LED driver circuit as claimed in claim 5, wherein the first sensing signal, the second sensing signal and the third sensing signal are respectively a first analog sensing signal, a second analog sensing signal and a third analog sensing signal.

7. The LED driver circuit as claimed in claim 6, wherein the control module comprises:
a first analog to digital converter, coupled to the first detection module for converting the first analog sensing signal to a first digital sensing signal;
a second analog to digital converter, coupled to the second detection module for converting the second analog sensing signal to a second digital sensing signal;
a third analog to digital converter, coupled to the photo sensor for converting the third analog sensing signal to a third digital sensing signal; and
a controller, coupled between the first, second and third analog to digital converters and the switch.
